(19) United States
(12) Patent Application Publication
(10) Pub. No.: US 2015/0151681 A1
(43) Pub. Date: Jun. 4, 2015

(54) Animal Aware

(71) Applicant: Carl Randolph, Cedar Hill, MO (US)

(72) Inventor: Carl Randolph, Cedar Hill, MO (US)

(21) Appl. No.: 14/449,670

(22) Filed: Oct. 27, 2014

Related U.S. Application Data
(60) Provisional application No. 61/963,132, filed on Nov. 25, 2013.

(51) Int. Cl. B60Q 9/00; B60Q 1/00; B60Q 5/00; G01S 13/93

(52) U.S. Cl. CPC B60Q 9/008; G01S 13/931; B60Q 1/00; B60Q 5/006

(57) ABSTRACT

An apparatus for stopping vehicle/animal accident collisions includes: (i) a radar unit including an inferred radar antenna that seeks out and retrieves heat sources in front of the vehicle with a full 180 degree left to right radios and a ½ mile distance range and then transfers that information to the main unit; (ii) a main unit to process the information and then sends the information to the display unit; and (iii) a display unit that works like a GPS letting the driver know where any animal, person, or heat source is at in proximity of the vehicle in real-time and/or alerts the drive to respond.

### TECHNICAL FIELD

This disclosure relates generally to a method and apparatus for stopping vehicle/animal accident collisions.

### BACKGROUND OF THE INVENTION

Collisions of vehicles in a big and serious problem in car driving, and there are a lot of researches and inventions have been done in the past years regarding to vehicle collisions and intelligent driving. The research and development focus on smart cars and preventing of collisions between vehicles on road driving, usually involving in complicated inbuilt systems and/or telecommunication between drivers.

One field having been ignored is that every year hundreds of vehicular accidents occur involving animals. A driver has no prior warning when an animal runs out in front of them, leaving them little time to safely react. An apparatus that can be easily installed on any vehicle to alert its driver of an object like an animal which is dangerous to driving is near is helpful in stopping vehicle/animal accident collisions and improving driving safety.

### SUMMARY OF THE INVENTION

A method and an Animal Aware apparatus are proposed for stopping vehicle/animal accident collisions. In a method for stopping vehicle/animal accident collisions, first the surroundings of a vehicle is detected by means of a radar unit to'determine if any object is within the alert zone; from the output signals of the radar unit, a risk level is determined and sent to a vehicle indication & response unit; and the vehicle indication & response (VIR) unit generates corresponding notification signals to alert drivers to react and process. An apparatus for stopping vehicle/animal accident collisions includes: (i) a radar unit to determine if any object is within the alert zone; (ii) a main module unit to determine a risk level; and (iii) a vehicle indication & response (VIR) unit that works like a GPS letting the driver know where any animal, person, or heat source is at in proximity of the vehicle in real-time and/or alerts the drive to respond.

Thus, with the proposed method and apparatus of the invention, the driver can be made aware of the risk situation by graphic and text information and/or optical and/or acoustical signals.

The method and apparatus of the invention will now be described in conjunction with the exemplary embodiments shown in the drawing.

### BRIEF DESCRIPTION OF THE DRAWINGS

FIG. 1 is a schematic block diagram of an embodiment of the apparatus for stopping vehicle/animal accident collisions in accordance with the present disclosure;

FIG. 2 is a flow chart of a method for stopping vehicle/animal accident collisions in accordance with the present disclosure.

FIG. 3 is a drawing of the apparatus antenna with brief description.

FIG. 4 is a drawing of the apparatus display monitor with brief description.

### DETAILED DESCRIPTION OF THE PREFERRED EMBODIMENTS

Hereinafter, the preferred embodiments of the invention will be described in detail with reference to the accompanying drawings. Note that the following embodiments are merely exemplary in nature and do not limit the aspects of the invention. In addition, components in the following embodiments can be omitted and/or replaced by persons skilled in the art without departure of the scope and spirit of the patent.

FIG. 1 is a schematic block diagram of an embodiment of the apparatus for stopping vehicle/animal accident collisions in accordance with the present disclosure.

The radar unit 11 form one of the most important unit as it helps in detecting surrounding condition. The radar unit 11 includes FMCW (Frequency Modulated Continuous Wave) radar that can determine the receiving wave's direction, and it can detect the interested object within a 180 degree left to right radios and notify the detected object's direction, distance and relative speed to the function module 12. The radar unit 11 including antenna can be easily mounted on the vehicle roof, which picks up signals from the object within a distance of about ½ mile and forwards the information to the main module unit 12.

Alternatively, the radar unit 11 can also include temperature, laser or radar based sensors and/or a camera or image system to get the position and moving information of the object.

The main module unit 12 receives information from the radar unit 11 and uses algorithms to determine if any object is within the alert zone and alert signals to be sent to and processed by the vehicle indication & response (VIR) unit 13 inside vehicle.

The vehicle indication & response (VIR) unit 13 is responsible for receiving and processing alert signal. It is a monitoring screen mounted inside the vehicle and displays in response of the main module unit 12, right on the dash mounted display. The display screen shows close animals as a red capital ‘A’ or blip icon & far distance animals as a green lower-case ‘a’ or blip icon (icons are average size). Cars on the display screen show as a lower-case ‘v’. This helps with every day driving and especially in inclement weather.

Alternatively, the VIR unit 13 includes an optical signal device and/or an acoustical signal device to alert the driver of a possible dangerous condition and a collision risk.

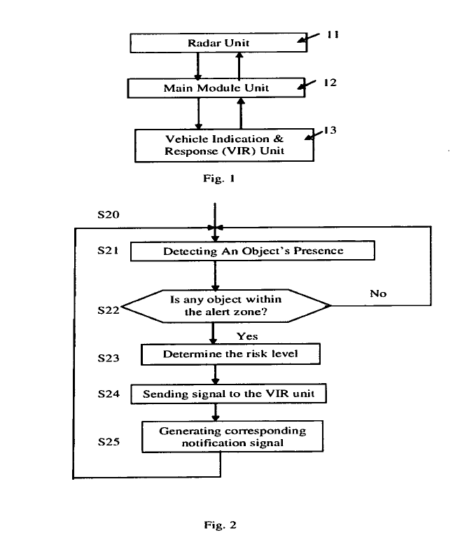

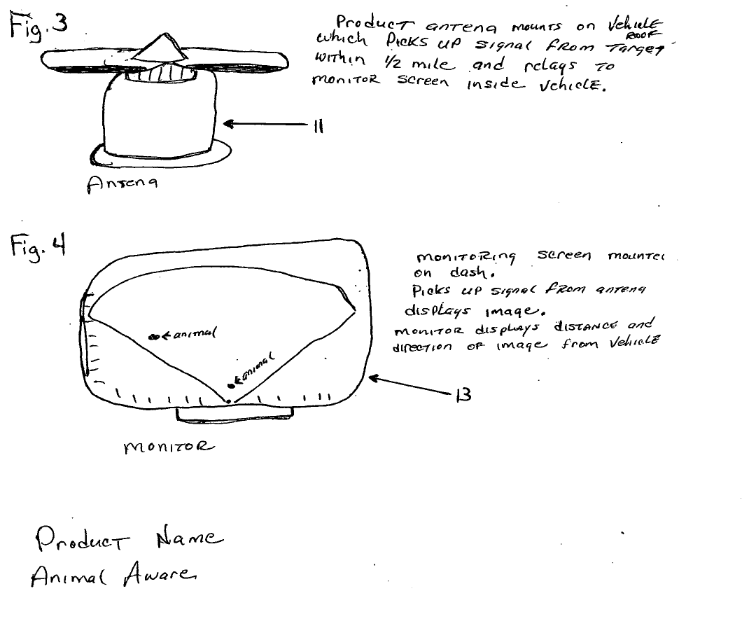

FIG. 2 is a flow chart of a method for stopping vehicle/animal accident collisions in accordance with the present disclosure.

In step S20, the system/method starts with the driver's operation. In step S21, the detection of any object's presence is determined depending on outputs of the radar unit 11 regarding to the objects' nature, distance, and relative speed. In step S22, it decides if there is any object within alert zone, and this is based on the objects' nature, distance, and relative speed, as well as the driver's response time, which is often dependent on the vehicle. If there is no object within alert zone, then it returns to Step S21. If YES, it continues to Step 23 to determine the risk level. The risk level is dependent on the zone and weather to drive, as well as the objects' nature, distance, and relative speed, as well as the driver's response time; The closer to the driving vehicle, the higher relative speed of the object, the higher risk level is given. The higher risk level involves more obvious alert such as red text, flashing light, and/or alarming sound. In step S24, once the risk level is obtained, the result is sent to the VIR unit 13 with a signal. Once receiving the risk level information, in step S25, the VIR unit 13 generates corresponding notification signal to alert the driver. After the driver's operation, it returns back to Step S21.

The algorithms of the method can be processed with programming logic circuit or a microprocessor, and some input parameters can be adjusted by the driver depending on the driving condition and the wishes of the driver.

As described above, the method and apparatus for stopping vehicle/animal accident collisions according to the aspect of the invention can be conveniently and less expensively used in any vehicle. It is helpful to increase driving safety, and is particularly suitable when driving in inclement weather and/or in zones with animals.

In the description of the disclosed apparatus, although the preferred non-limiting embodiments and its alternatives have specific illustrated components, the embodiments of this invention are not limited to those particular combinations. It is possible to use some of the components or features from any of the non-limiting embodiments in combination with features or components from any of the other non-limiting embodiments.

In the description of the disclosed method, although particular step sequences are listed and described, it is possible to perform the steps in any order, and the steps can be omitted, separated or combined.

The foregoing description is exemplary rather than defined by the limitations within. Additional detections and controls on the vehicle are possible.

It is therefore to be understood that the disclosure may be practiced other than as specifically described, and the scope the patent is defined in the appended claims.

1. A method for stopping vehicle/animal accident collisions, in which the 180 degree left to right front forward ½ mile distance of a vehicle is detected by means of a radar unit, wherein:
From the output signals of the radar unit, a risk level is determined and sent to a vehicle indication & response unit; and
As the risk level reaches a set value, the vehicle indication & response unit generates corresponding notification signals to alert drivers to react and process.

2. The method of claim 1, wherein the corresponding notification signals include a warning signal to the driver.

3. The method of claim 2, wherein the warning signal includes an optical signal and/or an acoustical signal.

4. The method of claim 2, wherein the warning signal includes graphic and/or text information about the object.

5. The method of claim 4, wherein the graphic and/or text information about the object include the distance and direction of object from the vehicle.

6. The method of claim 4, wherein the graphic and/or text information about the object include the image of the object.

7. The method of claim 1, wherein the radar unit includes an antenna, which picks up signals from the object and relays to the vehicle indication & response unit.

8. The method of claim 1, wherein the radar unit includes at least a sensor to get the position information of the object.

9. The method of claim 8, wherein the sensor is a temperature sensor.

10. The method of claim 1, wherein the vehicle indication & response unit includes at least one monitor screen inside the vehicle.

11. An apparatus for stopping vehicle/animal accident collisions, wherein the apparatus includes: (i) a radar unit to determine if any object is within the alert zone; (ii) a main module unit to determine a risk level; and (iii) a vehicle indication & response unit to alert the drive to respond.

12. The apparatus of claim 11, wherein the radar unit includes one or more of the following: an antenna, a radar unit, a sensor, a video system, and a radar system.

13. An apparatus of claim 11, wherein the main module unit processes the output signals of the radar unit, determines a risk level, and generates input signals for the vehicle indication & response unit.

14. The apparatus of claim 11, wherein the vehicle indication & response unit includes at least one of the following: a monitoring screen, an optical signal device, and an acoustical signal device.
